(19) United States
(12) Patent Application Publication
(10) Pub. No.: US 2017/0321867 A1
(43) Pub. Date: Nov. 9, 2017

(54) LUMINAIRE, LUMINAIRE CONFIGURATION METHOD, COMPUTER PROGRAM PRODUCT, COMPUTING DEVICE AND LIGHTING SYSTEM

(71) Applicant: PHILIPS LIGHTING HOLDING B.V., EINDHOVEN (NL)

(72) Inventors: JORIS HUBERTUS ANTONIUS HAGELAAR, EINDHOVEN (NL); JOHANNES PETRUS MARIA ANSEMS, EINDHOVEN (NL); ABRAHAM VAMATTATHIL SCARIA, EINDHOVEN (NL); AART JAN VROEGOP, EINDHOVEN (NL)

(21) Appl. No.: 15/525,798

(22) PCT Filed: Nov. 9, 2015
(86) PCT No.: PCT/EP2015/076002

§ 371 Date: May 10, 2017

(30) Foreign Application Priority Data
Nov. 13, 2014 (EP) 14193076.8

(51) Int. Cl. F21V 14/00; G02F 1/13; F21S 8/04; F21Y 2115/15; F21V 3/04; F21Y 2105/18

(52) U.S. Cl. CPC F21V 14/003; G02F 1/13; F21Y 2105/18; F21Y 2115/15; F21V 3/0445; F21S 8/043

(57) ABSTRACT

The invention provides a luminaire (100) comprising an array (102) of light exit windows (104, 104′, 104″, 204, 304′, 304″, 404′, 404″, 604, 804′, 804″, 804′″, 904′, 904″, 1004, 1004′, 1004″), wherein each light exit window comprises a material adjustable between at least a first state having a first translucence and a second state having a second translucence and an electrode arrangement (112) for adjusting said translucence of the material. Such a luminaire (100) can provide differing lighting effects whilst providing illumination and, additionally, differing aesthetic effects when viewed under ambient lighting. There is also provided a method of configuring the luminaire (1100), a computer program product for implementing the method (1200), a computing device including the computer program product (1300) and a lighting system comprising the luminaire (100).

### FIELD OF THE INVENTION

The present invention relates to a luminaire.

The present invention also relates to a method of configuring the luminaire, a computer program product for implementing the method and a computing device including the computer program product.

The present invention also relates to a lighting system comprising the luminaire.

### BACKGROUND OF THE INVENTION

IFTTT (If This Then That) technologies have been successfully integrated into lighting devices and luminaires. Such technologies may be considered responsive technologies in which a defined light output is produced in response to a defined precondition being met. For example, if it begins to rain the color of light emitted from a lighting device may be changed to blue, or if a user is tagged in a photograph on a social media web-site the light emitted from a lighting device may blink, as an alternative, a lighting device may turn on in the evening, e.g. at a specified time, e.g. 6 pm. Such conditional statements may be known as “recipes.” These technologies can convey useful information to consumers and provide greater convenience. These technologies also enable moves towards full home automation and integration.

It is desired to provide luminaires which both provide advanced functionality in terms of lighting effects and simultaneously have a pleasing aesthetic appearance, in particular, which can provide advanced functionality when the luminaire is not providing illumination.

### SUMMARY OF THE INVENTION

The invention inter alia seeks to provide a luminaire which can provide advanced functionality both whilst the luminaire is illuminated and whilst off.

The present invention yet further seeks to provide a method of configuring such a luminaire.

The present invention yet further seeks to provide a computer program product implementing such a method.

The present invention yet further seeks to provide a computing device including such a computer program product.

The present invention yet further seeks to provide a lighting system including the luminaire and the computer program product and/or the computing device.

According to an aspect, there is provided a luminaire comprising tessellated modular elements, each modular element comprising a light exit window, a set of solid state lighting elements configured to illuminate the light exit window, and an opaque wall structure, wherein the opaque wall structure is arranged for delimiting a luminous output of each set of solid state lighting elements to each respective light exit window, and wherein each light exit window comprises a material adjustable between at least a first state having a first translucence and a second state having a second translucence and an electrode arrangement for adjusting said translucence of the material.

Such a luminaire can provide differing lighting effects whilst providing illumination and, additionally, differing aesthetic effects when viewed under ambient lighting. These effects may be particularly advantageous when implemented in combination with IFTTT technologies, as information may be communicated to a user by the luminaire even when the luminaire is not providing illumination.

The light exit windows may be arranged in groups wherein each group is individually addressable. Each group may comprise a single light exit window or multiple light exit windows.

This can enable a large number of different lighting effects and luminaire appearances to be provided. These appearances may be observed both whilst the luminaire is illuminated and whilst the luminaire is viewed under ambient light.

The luminaire may further comprise a solid state lighting element contacting each light exit window of the array. The solid state lighting element may be an Organic Light Emitting Diode (OLED), for example a film OLED. In this arrangement the amount of light emanating from each light exit window may be varied independently. This can increase the number of lighting effects which can be produced by the luminaire.

The luminaire may comprise an array of sets of solid state lighting elements, wherein each set is configured to illuminate a respective light exit window. This is an alternative arrangement in which the light emanating from each light exit window may be individually controlled and which can, accordingly, provide a number of varying lighting effects.

Each set may be tunable to provide a selected colored light. This can enable the luminaire to provide a multiplicity of colored lighting effects. Such lighting effects may be desired in certain applications and may be produced on user instruction. Alternatively, the luminaire may be configured to provide a particular colored light in response to an IFTTT “recipe”, e.g. red in response to a text message and green in response to an e-mail.

The luminaire may further comprise an opaque wall structure for delimiting the luminous output of each set of solid state lighting elements to each respective light exit window. In this way the contrast between neighboring light exit windows can be enhanced and thereby a more striking luminous effect may be provided by the luminaire.

The opaque wall structure may be diffuse or specular reflective to reflect the luminous output of each set of solid state lighting elements to each respective light exit window. This can provide particular aesthetic appearances of the luminaire and can also provide particular lighting effects which may be desired in certain applications. Further, such a reflective wall structure may enhance the luminous efficiency of the luminaire.

The luminaire may comprise tessellated modular elements, each modular element comprising a light exit window and a set of solid state lighting elements configured to illuminate the light exit window. Use of such modular elements can enable the construction of a number of similar, but different, luminaires of various shapes in a cost-effective manner.

A modular design approach subdivides a system into smaller parts known as modules, these modules can be created independently and then used in different systems. This brings advantages in cost reduction as a smaller number of elements are required to build a large variety of luminaire shapes. There is less space required for storage as the luminaire can be flat-packed rather than boxed in the finished shape in which there is often a empty central region.

A modular approach may also allow the end user of the luminaire to reconfigure the luminaire in shape or color or other functionality when they move the luminaire from one room to another or when the room is redecorated. This can be achieved by simply purchasing a selection of modular elements in the desired shape or color and using these to alter the appearance of the luminaire that they already own.

To allow a higher degree of flexibility it is preferable that each modular element contains its own set of light elements and that a connector is provided to allow mechanical joining and electrical connectivity between modular elements.

It is also possible that the elements have a mechanical joining means arranged on the edges of the element whilst an electrical connector is located on the rear face of the modular element and a wire is used to connect to the next element.

A centralized driver may be provided to power all the elements via wires or it may be configured to power the elements through a series of connector traces that are applied to the element or even via internal wiring in each of the modular elements.

In another embodiment the driver may be used to power one or more modular elements, these elements may be arranged in a group so that different lighting effects or different colors may be provided by the luminaire.

A tessellation of a flat surface is the tiling of a plane using one or more geometric shapes, called tiles, with no overlapping portions and no gaps between the tessellated tiles.

Tessellated elements in two dimensions can fill a plane without any gaps according to sets of rules, these rules can be varied, commonly, one rule uis that no gaps are allowed between the elements and another is that no corner of one element can lie along the edge of another. The three shapes that can form such regular tessellations, these are the equilateral triangle, the square and the regular hexagon. Any one of these three shapes can be duplicated infinitely to fill a 2 dimensional plane with no gaps.

Many other types of tessellation are possible under different rules, for example, there are eight types of semi-regular tessellation made with more than one type of regular polygon but still having the same polygons at each corner. A rhombitrihexagonal tessellation is a tessellation using square, triangular and hexagon elements.

Tessellating a 3D shape can be described as a uniform tiling in hyperbolic plane. Hyperbolic tiling is an edge to edge filling of the hyperbolic plane which has regular polygons as faces and is vertex-transitive (i.e. there is an isometry mapping any vertex onto any other), it also follows that all vertices are congruent and the tiling has a high degree of rotational and translational symmetry.

The material of each light exit window may be a polymer dispersed liquid crystal material. Such materials may be relatively easily adjusted between discrete states having different translucence characteristics.

The material may be a single pixel across the entire light exit window; alternatively, the material may be pixelated. Where the material is pixelated the individual pixels may be addressed as in a display, in this way dynamic projections may be provided in certain applications.

The luminaire may have a substantially spherical outer shape, which can enable the luminaire to conveniently replace a traditional lamp shade, e.g. in the center of a room.

The shape of each of the light exit windows may be selected from the group consisting of: equilateral triangle, regular pentagon and regular hexagon. Additionally, the shape of the luminaire may be selected from the group consisting of: icosahedron and truncated icosahedron. Such shapes can provide particularly attractive luminaires.

According to a further aspect, there is provided a method of configuring a luminaire, wherein the luminaire is adapted to receive configuration instructions, the method comprising receiving user inputs specifying configuration instructions for configuring the materials of the luminaire and transmitting said configuration instructions to the luminaire. Such a method facilitates a user to (remotely) configure the luminaire, which may further aid user satisfaction.

According to a yet further aspect, there is provided a computer program product comprising a computer-readable storage medium comprising computer program code for, when executed on one or more processors of a computing device, implementing the method of configuring a luminaire. This facilitates the execution of the method on generic or dedicated computing devices, thereby improving flexibility.

According to a yet further aspect, there is provided a computing device including at least one processor and the computer program product wherein the at least one processor is adapted to execute the computer program code of said product. The computing device may be selected from the group consisting of a mobile phone, a phablet, a tablet, a desktop computer, a laptop computer, a personal organizer, a music player, such that the luminaire may be controlled by a generic computing device. Alternatively, the computing device may be a dedicated lighting controller, e.g. a dedicated remote controller of a luminaire or lighting system.

According to a yet further aspect, there is provided a lighting system comprising the luminaire according to one or more of the above embodiments and, the aforementioned computer program product and/or the aforementioned computing device. Such a lighting system benefits from the inclusion of a configurable luminaire having an appearance that can be adjusted whilst not providing illumination.

### BRIEF DESCRIPTION OF THE DRAWINGS

Embodiments of the invention are described in more detail and by way of non-limiting examples with reference to the accompanying drawings, wherein:

FIG. 1 shows a schematic perspective view of a luminaire according to an embodiment of the present invention in a first configuration;

FIG. 2 shows a schematic perspective view of the luminaire of FIG. 1 in a second configuration;

FIG. 3 shows a schematic perspective view of the luminaire of FIG. 1 in a third configuration;

FIG. 4 shows a schematic perspective view of the luminaire of FIG. 1 in a fourth configuration;

FIG. 5 schematically depicts the luminaire of FIG. 1;

FIG. 6 shows a schematic cross-sectional view of a modular element which can be used to make up luminaires according to embodiments of the present invention;

FIG. 7 shows a schematic cross-sectional view of a luminaire according to an embodiment of the present invention;

FIG. 8 shows a schematic end on views of further modular elements which can be used to make up luminaires according to embodiments of the present invention;

FIG. 9 shows a schematic perspective view of a luminaire according to another embodiment of the present invention;

FIG. 10 shows a schematic perspective view of a luminaire according to yet another embodiment of the present invention;

FIG. 11 depicts a flow chart of a method according to an embodiment of the present invention;

FIG. 12 depicts a computer program product according to an embodiment of the present invention; and

FIG. 13 depicts a computing device according to an embodiment of the present invention.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

Embodiments of the present invention are concerned with luminaires, in particular luminaires having advanced functionality. An area identified for improvement is the provision of luminaires having advanced functionality even when they are not providing illumination.

In the following, where it is stated that a material of the luminaire has a first or a second translucence this means that the material has a particular degree of translucence. For instance, the material may have a high degree of transparency as a first translucence and a low degree of transparency, e.g. be diffusive or scattering, as a second translucence or vice versa; the first translucence may be greater than the second translucence, in other words, the second translucence may be more transparent than the first translucence. In other embodiments the second translucence may be greater than the first translucence, in other words, the first translucence may be more transparent than the second translucence.

In the present application, where reference is made to a material adjustable between a first translucence and a different second translucence, it should be understood that this includes materials for which the translucence may be gradually adjusted, i.e. a material comprising an infinite number of translucent states that may be invoked by employing an appropriate voltage across the material.

Where reference is made to a set of solid state lighting elements, such a set may comprise only a single solid state lighting element; alternatively, such a set may comprise multiple solid state lighting elements. Where a set comprises multiple solid state lighting elements, the solid state lighting elements may be arranged in an array. Another alternative is for a set to comprise a large pixelated solid state lighting element. The solid state lighting elements may be light emitting diodes (LEDs). Different sets may contain the same or different solid state lighting element arrangements relative to each other. Other alternative sets and elements will be apparent to the skilled person.

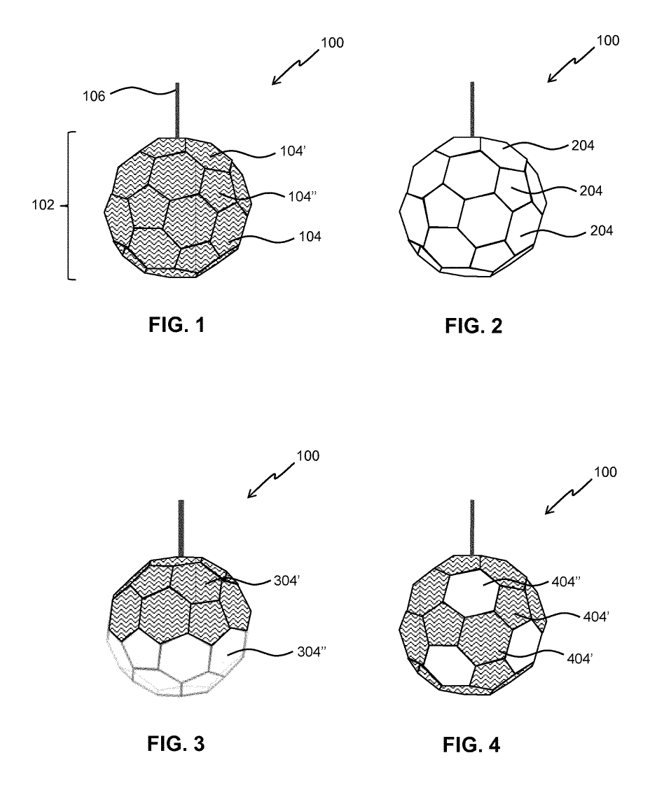

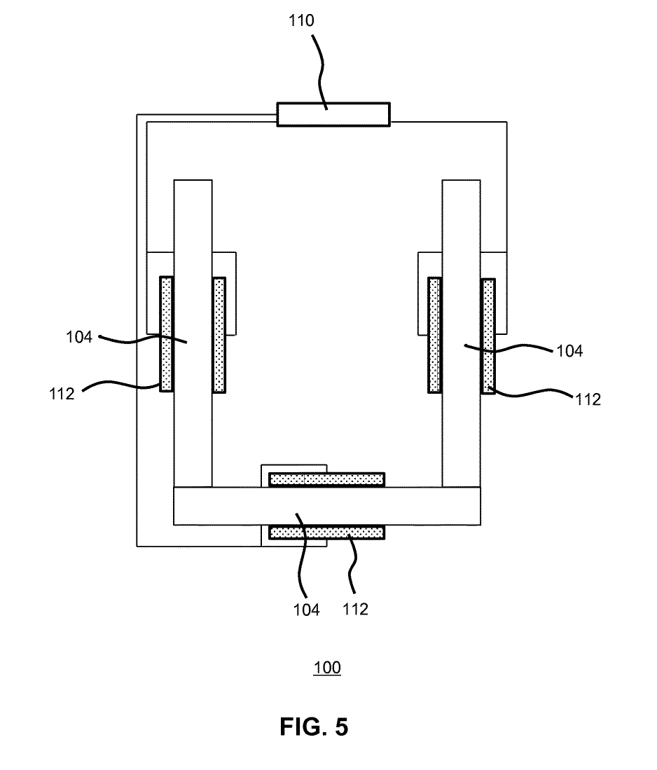

Referring firstly to FIGS. 1 and 5 of the accompanying drawings, an embodiment of a luminaire 100 can be seen to comprise an array 102 of light exit windows 104. Each light exit window comprises a material adjustable between a first state having a first translucence and a second state having a second translucence, such that the material can be switched between a state in which its translucence is relatively high and a state in which its translucence is relatively low (i.e. it is relatively transparent). In this way the luminaire can provide different lighting effects and, additionally, have differing appearances when the luminaire is not providing illumination, e.g. when it is daytime. For example, in the configuration illustrated in FIG. 1, the light exit windows 104 are relatively translucent and the luminaire 100 has a frosted appearance, even when not providing illumination. In another configuration illustrated in FIG. 2, the light exit windows 204 are relatively transparent and the luminaire 100 has a transparent appearance, even when not providing illumination. Whilst the luminaire 100 is providing illumination, the user may observe a soft lighting effect in the configuration illustrated in FIG. 1, whereas in the configuration illustrated in FIG. 2 a more direct or concentrated lighting effect may be observed by the user. Accordingly, the user can not only change lighting effects of the luminaire 100 in relative darkness, e.g. after sunset, but also change the appearance of the luminaire 100 when viewed under ambient lighting, i.e. the appearance of the luminaire 100 per se. The luminaire 100 may be switched between the states illustrated in FIGS. 1 and 2, and other states which will be described below, in response to user inputs, in response to “recipes” or other conditions, as discussed in more detail below.

In order to facilitate the adjusting of the materials of the light exit windows between the first and second states the light exit windows 104 of the array 102 comprise an electrode arrangement 112 as schematically illustrated in FIG. 5. The arrangement 112 is constructed such that it can adjust the material between these different translucent states by applying an appropriate voltage across the material. The electrodes of the electrode arrangement 112 may be arranged in any suitable arrangement. The electrodes of the electrode arrangement 112 preferably are made of a transparent electrically conductive material, e.g. an electrically conductive oxide material such as Indium Tin Oxide (ITO), Fluorine-doped Tin Oxide (FTO), Indium Zinc Oxide (IZO), carbon nanotube-based materials, graphene-based materials or any other suitable transparent electrically conductive material.

In order to provide the electrode arrangements 112 with appropriate voltages in order to adjust the materials and provide a range of different lighting effects, the luminaire 100 may further comprise a controller 110 configured to switch the luminaire 100 between its different modes of operation. To this end, the controller 110 is electrically connected to the electrode arrangements 112 for adjusting the material of the light exit windows 104, wherein the controller 110 is configured to adjust appropriate group(s) of materials in accordance with the selected mode.

Alternatively, a controller may be omitted from the luminaire 100 and, for instance, the materials may be controlled by an external controller, in which case the luminaire 100 may comprise a plurality of control terminals for providing external control signals to materials of the light exit windows 104.

The controller 110 may be configured to receive configuration instructions and control the materials in accordance with said configuration instructions, as will be described in more detail below.

The material of each light exit window 104 may be any suitable material that can be adjusted between states having different translucencies. In an embodiment, the material is a polymer dispersed liquid crystal (PDLC) material. Other acronyms are also used for such liquid crystal systems. Apart from PDLC (polymer dispersed liquid crystal), the terms PNLC (Polymer Network Liquid Crystal), LCPC (Liquid Crystal Polymer Composite), NCAP (Nematic Curvilinear Aligned Phase) and PSCT (Polymer Stabilized Cholesteric Texture) are used. Such materials comprise liquid crystals which are dissolved or dispersed in a polymer material. A PDLC material is essentially a matrix material in which droplets of liquid crystal are dispersed. Dispersion of the liquid crystal in the polymer can be obtained through methods of emulsion or phase separation. The emulsion may be polyvinyl alcohol (PVA) based, latex based or water based. Phase separation methods include polymerization induced phase separation, thermally induced phase separation and solvent induced phase separation.

For polymerization of the matrix material derivatives of the acrylate, methacrylate or vinyl families may be used. Alternatively thiolene and polyurethane or ring-opening polymerization reactions such as epoxy chemistry can be used. The liquid crystal itself can be non-chiral and chiral liquid crystals. Dichroic dies can be incorporated into some types of PDLC films which enable the device to change from scattering into an absorbing state instead of a transparent state.

The optical properties of such a material may be controlled by applying a voltage across the PDLC material. Without the application of a voltage, the liquid crystals are randomly arranged, resulting in scattering of light as it passes through the material, yielding a diffuse state. This results in the material having a translucent, scattering, effect consequently the material may have an opaque appearance, e.g. appear ‘milky’. PDLC materials can be contrasted with twisted nematic displays which use variable absorbance; PDLCs can modulate light through a controllable scattering effect without the need for polarizers. The principal advantage of this is that PDLC materials have higher optical output.

When a voltage is applied to the material, the resulting electric field across the material causes the liquid crystals to align, thereby allowing light to pass through the material with very little scattering and resulting in a transparent state. Alternatively, in some embodiments the liquid crystals may be pre-aligned, such that without an applied voltage the film is transparent. Upon application of a voltage the liquid crystals align in such a way that the liquid crystals scatter light. This is more complex arrangement which may be less favored, as this arrangement may be less cost-effective. In both systems, it is common to apply an AC voltage in order to prevent or at least substantially reduce electromigration of the liquid crystal droplets.

In this way, the degree of transparency can be controlled and adjusted by the applied voltage. For example, at lower voltages, only a few of the liquid crystals align completely in the electric field, and/or the liquid crystals only partially align, so only a small portion of the light passes through unscattered whilst most of the light is scattered. As the applied voltage is increased, fewer liquid crystals remain out of alignment, resulting in less light being scattered. PDLC materials have been commonly used for other applications, such as privacy control and are therefore well-known per se. Any suitable PDLC material may be used as the material of the light exit window 104.

The material may define a single pixel across an entire light exit window 104, in which case an electrode arrangement is present having a single pair of electrodes for addressing the full area of the material; alternatively, the material may be pixelated in which case an electrode is present comprising a plurality of electrode pairs each arranged to address a separate region of the material. In other words, where the material is pixelated the individual pixels may be addressed as in a display, in this way dynamic projections can be provided.

Alternatively, any other material may be used which is capable of being adjusted between at least a first state having the first translucence and a second state having a second translucence. Such materials for instance are commonly used in technical fields such as smart glasses or switchable glass technologies. A non-exclusive list of such technologies includes electrochromic, photochromic, thermochromic, suspended particle and micro-blind technologies.

The shape of each of the light exit window 104 may be selected from the group of shapes comprising: equilateral triangle, regular pentagon and regular hexagon. Other shapes may also be considered, but may be less suitable to create a substantially spherical luminaire 100. In FIG. 1, the luminaire 100 is illustrated as having hexagonal 104′ and pentagonal 104″ light exit windows by way of non-limiting example. As a further alternative, the luminaire 100 may have square light exit windows 104 and be substantially cubic, other alternatives will be apparent to the skilled person.

The luminaire may have a regular shape. For example, the shape of the luminaire may be selected from the group consisting of: icosahedron and truncated icosahedron, which are considered example embodiments of a substantially spherical luminaire 100. In FIG. 1, the luminaire 100 illustrated in FIG. 1 is a truncated icosahedron. Not all faces of the regularly shaped luminaire 100 need necessarily be light exit windows 104, for example and as shown in FIG. 1, a hexagon is omitted for the truncated icosahedron for the luminaire to be attached to the mounting 106.

The edges of neighboring light exit windows 104 may meet. This may enhance the visual effects provided by the luminaire, both when the luminaire 100 is illuminated and when the luminaire 100 is not providing a luminous effect. The desired visual effect may be enhanced as a greater percentage of the total surface area of the luminaire 100 is a light exit window in such a scenario, such that a greater percentage area of the luminaire 100 is capable of providing luminous effects and also changing appearance when illuminated by ambient lighting.

In some embodiments, the light exit windows 104 are on the outer surface of the luminaire 100. This can enable the visual effects of the change in state of the materials to be strikingly apparent to a user and thereby provide more dramatic effects, both when the luminaire 100 is providing illumination and when the luminaire 100 (when in an off-state) is being observed under ambient light. This is so simply because the effect of the change of the state of the light exit windows 104 is not obstructed by other elements.

The luminaire 100 can provide dynamic effects in which the materials of the light exit windows 104 change state over time, for example the luminaire 100 may be configured to oscillate between the states illustrated in FIGS. 1 and 2 over a period of time. Such dynamic effects may be achieved by configuring the controller 110 to adjust the materials of the light exit windows in a specified way over a specified period of time.

As previously explained and shown in FIGS. 1 and 2, in some configurations all of the materials in the light exit windows 104 may have the same translucence. Alternatively, the materials of the light exit windows 104 may be arranged in groups wherein each group is individually addressable such that the materials of different groups of light exit windows 104 may have different translucencies. Each group may comprise a single material of a single light exit window or multiple materials of multiple light exit windows.

In this way additional lighting effects may be provided. For example, as shown in FIG. 3, the light exit windows 304′ of the array which are in the top half of the luminaire may have the first translucence (e.g. more translucent) and the light exit windows 304″ which are in the bottom half of the luminaire may have the second translucence (e.g. less translucent, such as relatively transparent). This effect will be visible whilst the luminaire 100 is not providing illumination by direct observation of the luminaire 100 under ambient lighting. Additionally, this effect will be visible whilst the luminaire 100 is providing illumination, both by direction observation of the luminaire 100 and by the nature of the illumination provided. For example, as illustrated in FIG. 3 in a state in which the materials in the light exit windows 304′ at the top of the luminaire 100 are diffuse and the materials in the light exit windows 304″ at the bottom are transparent, most of the light from the luminaire 100 will be directed downwards.

As another example illustrated in FIG. 4, the materials of certain light exit windows 404′ of the array may be configured to have the first translucence (e.g. relatively translucent) whilst other materials of certain other light exit windows 404″ may be configured to have the second translucence (e.g. relatively transparent). In this way the luminaire 100 can be configured to have a patterned appearance, this appearance will be apparent both in the lighting effect provided by the luminaire when the luminaire is providing illumination and by direct observation of the luminaire 100 when it is not providing illumination and it is observed under ambient light, e.g. during the day.

The luminaire 100 could be lit by traditional means, for example the luminaire 100 could replace a traditional luminaire, such as a lamp shade. In this instance, the luminaire 100 might comprise a socket to receive a traditional incandescent light bulb. Alternatively, the luminaire 100 could comprise a fitting which attaches to an existing light fitting, akin to some common lamp shades, as is known in the art. Instead of a traditional incandescent light bulb a compact fluorescent replacement light bulb may be used. Alternatively, a solid state (e.g. LED) light bulb replacement may be used; such solid state lighting devices are gaining in popularity due to their favorable energy efficiency and relatively low environmental impact. If a traditional incandescent light bulb is to be used within the luminaire 100 then, as such light bulbs often produce significant amounts of heat, the distance between such a light bulb and the material of the light exit windows 104 should be large enough to ensure a good thermal barrier between light source and the material particularly where the material chosen is sensitive to heat.

Alternatively, a solid state lighting element may be provided contacting each light exit window. The solid state lighting element may be an Organic Light Emitting Diode (OLED). OLEDs are particularly attractive, because they can be provided as highly transparent films, such that they can be applied to a light exit window without significantly affecting the adjustable translucent nature of such a window. For example, an OLED film may be applied on the light exit window, i.e. contacting the light exit window. The OLED may have transparent electrodes. In this case, the function of the material would be the same as described above. It could still be used to change the luminaire's appearance when the luminaire 100 is not providing illumination. When the luminaire 100 is providing illumination, specific light exit windows 104 can be switched on selectively, depending on the desired light distribution. With reference to FIG. 3, if it is desired that most of the light should go downwards, the OLED film of the light exit windows 304″ facing downwards could be switched on while the material is in the relatively transparent state. The OLED film may have a transparent backing member such that the OLED would shine both towards the outside and the inside of the luminaire 100, the light going inside the luminaire could also be diverted downwards again. This can be achieved by adjusting the material on the light exit windows 304′ of the luminaire facing upwards to the relatively diffuse state and keeping the OLED film of these light exit windows 304′ switched off.

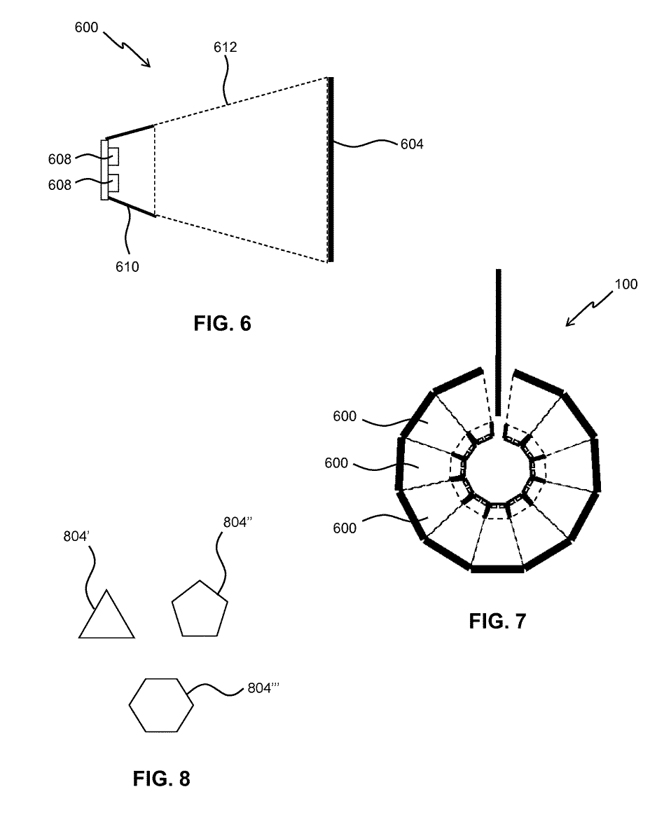

The luminaire 100 may comprise an array of sets of solid state lighting elements, wherein each set is configured to illuminate a respective light exit window. An example way of achieving this is illustrated with respect to FIG. 6. FIG. 6 shows a modular element 600 comprising a light exit window 604 and a set of solid state lighting elements 608 configured to illuminate the light exit window 604.

A number of modular elements 600 may be tessellated to form a luminaire 100. Such an arrangement is illustrated in schematic cross-section in FIG. 7.

The use of such modular elements 600 allows for relatively simple construction of a number of similar, but different, luminaires 100 of various shapes. For example, as shown in FIG. 8 the light exit window of the modular element 600 may be triangular 804′, pentagonal 804″ or hexagonal 804′″. In such cases, the cross sectional shape of the modular element 600 perpendicular to its long axis is triangular, pentagonal or hexagonal, respectively. This can ensure that different three dimensional luminaire shapes can be constructed without any openings or slits between the light exit windows 804, which may be advantageous, as explained above.

Returning to FIG. 6, the modular element 600 of the luminaire 100 may further comprise an opaque wall structure 610 for delimiting the luminous output of each set of solid state lighting elements 608 to each respective light exit window. The modular element 600 may also comprise a spacer 612. The spacer 612 may be transparent. Alternatively, the spacer 612 may be opaque in which case it may form part of the opaque wall structure.

The set of solid state lighting elements 608 could comprise an arrangement of LEDs, for example an LED engine. The LED arrangement could comprise white emitting LEDs of a specific color temperature, LEDs of a specific color or LEDs of different colors that constitute a tunable color light engine, the gamut of which is spanned by the color point of the different LED colors applied. In other words, each set of solid state lighting elements 608 may be tunable to provide a selected colored light.

An example of a truncated icosahedron (“football-shaped”) luminaire that can be built up from modular elements 600 is shown in FIG. 7. The functionality and advantages of the material of the light exit windows in the off state (where no illumination is provided) of the luminaire 100 is as described above. This arrangement can provide a particularly distinctive look and feel.

With the material of the light exit windows in the second (e.g. relatively transparent) state, the light engine and optics (e.g. opaque wall structure 610 and spacer 612, if present) will be visible. Therefore the aesthetics of the luminaire 100 may be affected by the components inside the luminaire 100. This provides a number of options to change this look and feel of the luminaire 100.

For instance, the opaque wall structure 610 can enhance the contrast between neighboring light exit windows 604, e.g. when one light exit window is illuminated and the other light exit window is not illuminated.

For example, the opaque wall structure 610 may be diffuse or specular reflective to reflect the luminous output of each set of solid state lighting elements to each respective light exit window. Such a reflective wall structure 610 can help ensure that most of the light generated by the sets of solid state lighting elements 608 exits the luminaire through the respective light exit window 604.

The reflective material of the opaque wall structure 610 could be a highly reflective white part, yielding a white look and feel. Such an appearance may be particularly apparent when the materials of the light exit windows 604 are in the relatively transparent state.

Alternatively, the reflective material of the opaque wall structure could have a smooth metal surface for specular reflection and hence provide a shiny look and feel to the luminaire 100.

The size (height) of the opaque wall structure 610 may also be adjusted to change the overall appearance of the luminaire 100. As illustrated in FIG. 6, the opaque wall structure could have a relatively limited height, with the gap between the opaque wall structure 610 and the material of the light exit window 604 filled by a transparent spacer 612. This can provide a luminaire 100 with a more transparent look and feel, this will be particularly apparent when then material of the light exit windows 604 is in the relatively transparent state.

Alternatively, the opaque wall structure 610 could extend to the light exit window 604. In such a case, the (transparent) spacer 612 can be omitted. In this case, the luminaire may have a completely shiny or white appearance when the material of the light exit window 604 is in the more transparent state. Of course any configuration of first and second states of the materials of the light exit windows is possible, regardless of the materials used to construct the luminaire 100 or modular elements 600.

As will be appreciated, a reflective opaque wall structure 610 can help increase the overall luminous efficiency of the device by ensuring that more of the light emitted by the sets solid state lighting elements 608 reaches the respective light exit window 604.

Further, the wall structure 610 may be shaped so as to provide chosen lighting effects; this may be particularly effective when the wall structure is reflective. For example, a reflective wall structure 610 may be shaped so as to provide relatively focused light from the light exit window 604, for example, by having a net concentrating or focusing effect. Such an effect may be particularly dramatic when the material of the light exit window 604 is in the relatively transparent state.

In some embodiments, it may be desired to alter the aesthetics of the sets of solid state lighting elements 608 by covering them with a diffuse material (e.g. diffuse plastic or glass) to make the solid state lighting elements appear whiter.

As will be understood by the skilled person, features of modular elements 600 which make up luminaires 100 as described above may be incorporated in luminaires which do not comprise modular elements. For example, a luminaire 100 may comprise an opaque wall structure for delimiting the luminous output of sets of solid state lighting elements, although not provided as part of a modular element. This applies to all other features of the modular elements 600 discussed above; the use of modular elements 600 is merely one relatively expedient way of assembling luminaires 100 having the above features.

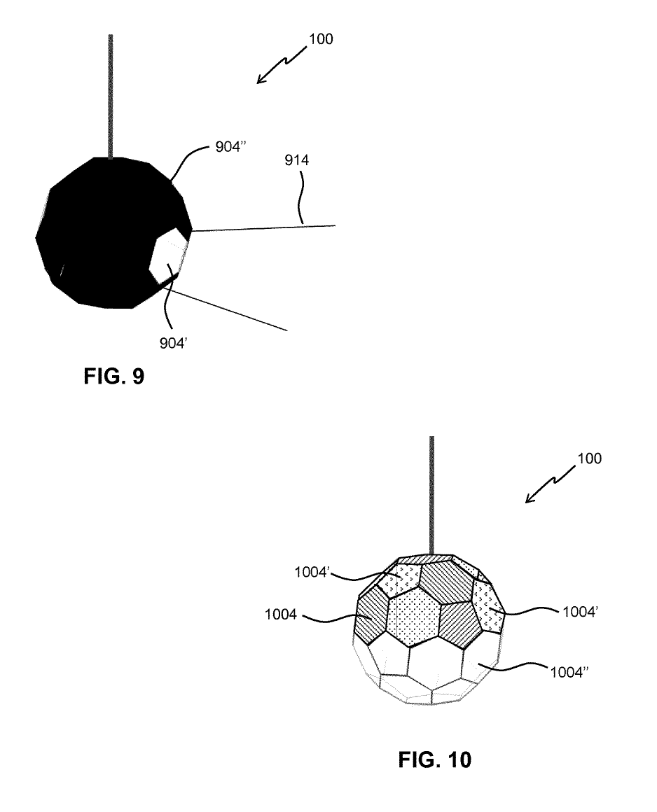

As illustrated with respect to FIG. 9, luminaires 100 comprising an array of sets of solid state lighting elements may be favorable for certain applications. For example, a spot beam effect may be created if the material of a light exit window 904′ is in the relatively transparent state. Such an effect may be particularly apparent when used with a reflective wall structure shaped so as to provide relatively focused light from the light exit window 604, previously described. Additionally, when adjusted to the relatively diffuse state, the beam of the single optical element may be made Lambertian.

In the extreme case illustrated in FIG. 9, only a single light engine in the total luminaire 100 may be lit. If the material of the corresponding light exit window 904′ is in the relatively transparent state, only a single sharp spot beam 914 may be produced from the luminaire 100. Additional optics may be used to provide a collimated beam. It is possible to change the angle of the spot beam 914 by lighting another set of solid state lighting elements and making the material of the corresponding light exit window relatively transparent. This change can be implemented dynamically that is, moving light effects can be created. As described above, such dynamic effects may be achieved by appropriate configuration of a controller 110.

In another example illustrated in FIG. 10, the light exit windows 1004 of the luminaire 100 can be colored by the light engine inside (for example, by providing sets of solid state lighting elements which are tunable to provide a selected colored light), not with the intention to light up a wall or table with colored light, but instead to give that light exit window 1004 a certain color. This may be achieved by switching the set of solid state lighting elements to a specific color at a relatively low light output whilst the material of the corresponding light exit window is in the relatively diffuse state. An example of a luminaire 100 in a configuration with different light exit windows 1004′ having different colors is shown in FIG. 10, the light exit windows 1004″ facing downwards are colorless and can provide functional light, with the material of these light exit windows 1004″ in either the relatively translucent or relatively transparent state, depending on the desired lighting effect to be produced.

The luminaire 100 may have a substantially spherical outer shape. Such a shape may be advantageous where the luminaire is used to replace a conventional lamp shade or chandelier, conventionally placed near the center of a room. Of course, as illustrated in the accompanying Figures, although the luminaire 100 may have a substantially spherical outer shape, the light exit windows 104 may be planar and there may be straight line edges and vertices between the light exit windows 104. Alternatively, the luminaire may comprise a wall mounted decorative frame. Other arrangements will be apparent to the skilled person.

In an embodiment, the controller 110 is configured to receive configuration instructions and control the materials (and optionally, if present, the solid state lighting elements) in accordance with the received configuration instructions. The configuration instructions may comprise on/off instructions and/or light intensity levels for the solid state lighting elements, if present, and switching instructions for the adjustable materials. Alternatively, the configurations instructions may comprise a desired lighting effect, in which case the controller may be adapted to process the configuration instructions in order to determine intensity and switching states for the adjustable materials and control the solid state lighting elements and the materials accordingly.

The controller 110 may include a receiver for wirelessly receiving the configuration instructions. In this embodiment, the luminaire 100 may further comprise an antenna functionally (not shown) connected to the controller 110, wherein the antenna is configured to wirelessly receive said configuration instructions and relay the received configuration instructions to the receiver of the controller 110. This can simplify retrofitting of the luminaire around fittings for traditional lighting devices, such as incandescent light bulbs. For example, the luminaire 100 may comprise a fitting used for traditional lamp shades and the configurations of the luminaire may be controlled wirelessly. Such an installation may be simple and therefore cost-effective. Any suitable wireless communication protocol may be used for the wireless communication with the luminaire 100, e.g., an infrared link, Zigbee, Bluetooth, a wireless local area network protocol such as in accordance with the IEEE 802.11 standards, a 2G, 3G or 4G telecommunication protocol, any suitable proprietary protocol, and so on.

Alternatively, the luminaire 100 may be configured by wired communication, in which case the controller 110 may include a receiver for receiving the configuration instructions in a wired fashion. For example, one or more dedicated wires may be supplied to the luminaire 100 in order to provide the luminaire 100 with such configuration instructions. As another example, configuration instructions may be transmitted to the luminaire 100 by modulating the power signal supplied to a lighting device within the luminaire 100, wherein the modulation includes the configuration instructions. Such an arrangement may obviate the need for the installation of additional wires to the location in which the luminaire 100 is to be fitted; this may be a simple, and therefore cost-effective, installation of the luminaire 100.

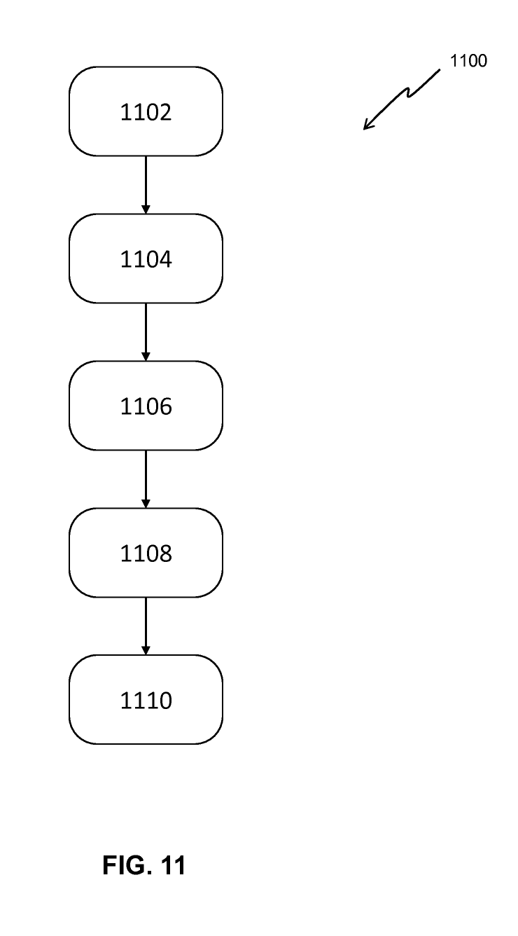

FIG. 11 depicts a flow chart of a method 1100 for configuring the luminaire 100. The method 1100 starts in step 1102 which may include powering up systems for implementing the method, such as switching on a control device used for configuring the luminaire 100. The method subsequently proceeds to step 1104, in which user inputs are received on the control device, for example through a user interface (UI). The user for instance may provide configuration instructions for configuring the materials of the light exit windows and any light source (e.g. solid state lighting elements), for example, by selecting a predefined operating mode of the luminaire 100 or by actually defining the desired operating mode.

The user may provide configuration instructions in step 1104 which comprise instructions to co-ordinate the lighting configuration to operate in tandem with other lighting configurations, e.g. lighting configurations of further devices, for example, lighting devices which provide colored or other effects. Additionally or alternatively, the user may provide instructions to configure the luminaire in response to a timer, for example, to provide a particular lighting configuration at 6 am to function as an alarm clock. Additionally or alternatively, the user may provide instructions in step 1104 to configure the luminaire in response to a notification such as a text message or an e-mail in order to notify a user of such an occurrence. As will be apparent, such notifications may be provided to a user even when the luminaire 100 is not providing illumination, for example when the e-mail inbox of a user is empty the luminaire may be fully translucent (as illustrated in FIG. 1) and when a user receives an e-mail the luminaire may be fully transparent (as illustrated in FIG. 2) these effects are observable even when the luminaire 100 is not providing illumination, as discussed above.

The configuration instructions are subsequently transmitted in step 1106 to the luminaire 100. In response to receiving the configuration instructions, the controller 110 of the luminaire 100 may accordingly configure the luminaire 100 in step 1108, after which the method terminates in step 1110.

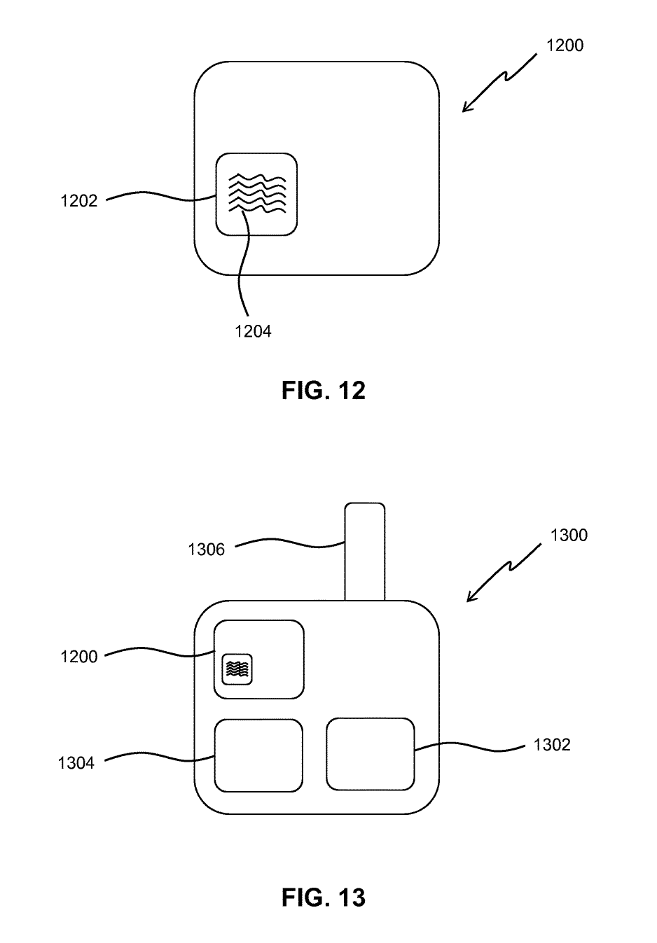

As illustrated in FIG. 12, the method 1100 may be a computer-implemented method stored on a computer program product 1200 comprising a computer-readable storage medium 1202 embodying computer program code 1204 for, when executed on one or more processors of a computing device, implementing the method 1100 of configuring a luminaire. In an embodiment, the computer program product 1200 may be made available on a server, e.g. hosting an application store, in which case the computer program code 1204 may come as an app to be installed on the computing device 1200.

FIG. 13 schematically depicts an example embodiment of such a computing device 1300 including at least one processor 1302 and the computer program product 1200, wherein the at least one processor 1302 is adapted to execute the computer program code 1304 of said product 1200. The computing device 1300 may further comprise a user interface 1304 for receiving user instructions, as will be familiar to the skilled person. Any suitable user interface, e.g. a keypad, touch screen, a movement sensor such as a gyroscope for detecting a movement-based user instruction, e.g. a head, hand or arm movement or the like, an image sensor for capturing a gesture-based user instruction, and so on may be considered.

The computing device 1300 may further comprise an antenna 1306 for wirelessly transmitting configuration instructions to the luminaire 100, as is known in the art.

The computing device 1300 may be any one of a large number of different computing devices. Consumer electronics devices having significant computing power for executing the computer program product have increased in popularity, such that it is common for an individual to own a number of such devices. A particularly prevalent computing device suitable for executing the computer program product is a mobile phone, which has the advantage of being portable and often readily available to a user.

The computing device alternatively may be selected from the group consisting of a phablet, a tablet, a desktop computer, a laptop computer, a personal organizer, a music player and a dedicated lighting controller. These devices are prevalent and readily available in a number of environments.

The luminaire 100 according to any embodiment of the invention may advantageously be included in a lighting system comprising the luminaire 100. The lighting system may further comprise the computer program product and/or the computing device described above. Additionally or alternatively the lighting system may further comprise other lighting devices, e.g. lighting devices which provide different effects, e.g. colored effects, such as those available as part of the Philips Hue system. The system may also comprise bridge units for interfacing between proprietary wireless networks specifically designed to connect multiple luminaires and/or lighting devices together and conventional home networks, such as Wi-Fi networks.

Aspects of the present invention may be embodied as a luminaire, method, computer program product, computing device and/or lighting system. Aspects of the present invention may take the form of a computer program product embodied in one or more computer-readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Such a system, apparatus or device may be accessible over any suitable network connection; for instance, the system, apparatus or device may be accessible over a network for retrieval of the computer readable program code over the network. Such a network may for instance be the Internet, a mobile communications network or the like. More specific examples (a non-exhaustive list) of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of the present application, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out the methods of the present invention by execution on at least one processor of a computing device may be written in any combination of one or more programming languages, including an object oriented programming language such as Java, Smalltalk, C++ or the like and conventional procedural programming languages, such as the “C” programming language or similar programming languages. The program code may execute entirely on the at least one processor as a standalone software package, e.g. an app, or may be executed partly on the at least one processor and partly on a remote server. In the latter scenario, the remote server may be connected to the computing device through any type of network, including a local area network (LAN) or a wide area network (WAN), or the connection may be made to an external computer, e.g. through the Internet using an Internet Service Provider.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions to be executed in whole or in part on the at least one processor of the computing device, such that the instructions create means for implementing the functions/acts specified in the flowchart and/or block diagram block or blocks. These computer program instructions may also be stored in a computer-readable medium that can direct computing device to function in a particular manner.

The computer program instructions may be loaded onto the at least one processor to cause a series of operational steps to be performed on the at least one processor, to produce a computer-implemented process such that the instructions which execute on the at least one processor provide processes for implementing the functions/acts specified in the flowchart and/or block diagram block or blocks. The computer program product may form part of a computing device 100, e.g. may be installed on the computing device.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. A single controller, processor or other unit may fulfil the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems. In the device claim enumerating several means, several of these means can be embodied by one and the same item of hardware. The mere fact that certain measures are recited in mutually different dependent claims does not indicate that a combination of these measures cannot be used to advantage.

1. A luminaire comprising:
tessellated modular elements, each modular element comprising
alight exit window,
a set of solid state lighting elements configured to illuminate the light exit window,
an opaque wall structure,
wherein the opaque wall structure is arranged for delimiting a luminous output of each set of solid state lighting elements to each respective light exit window, and wherein each light exit window comprises:
a material adjustable between at least a first state having a first translucence and a second state having a second translucence, and
an electrode arrangement for adjusting said translucence of the material.

2. A luminaire according to claim 1, wherein the light exit windows are arranged in groups and each group is individually addressable.

3. A luminaire according to claim 2, wherein each group comprises a single light exit window or multiple light exit windows.

4. A luminaire according to claim 1, further comprising a solid state lighting element contacting each light exit window of the array.

5. A luminaire according to claim 1, wherein each set of solid state lighting elements is tunable to provide a selected colored light.

6. A luminaire according to claim 1, wherein the material of each light exit window is a polymer dispersed liquid crystal material.

7. A luminaire according to claim 1, wherein the luminaire has a substantially spherical outer shape.

8. A luminaire according to claim 1, wherein the shape of each of the light exit windows is selected from the group consisting of: equilateral triangle, regular pentagon and regular hexagon.

9. A method of configuring a luminaire according to claim 1, wherein the luminaire is adapted to receive configuration instructions,
the method comprising:
receiving user inputs specifying configuration instructions for configuring the materials of the luminaire; and
transmitting said configuration instructions to the luminaire.

10. A computer program product comprising a computer-readable storage medium comprising computer program code for, when executed on one or more processors of a computing device, implementing the method of claim 9.

11. A computing device including at least one processor and the computer program product of claim 10 wherein the at least one processor is adapted to execute the computer program code of said product.

12. A lighting system comprising:
the luminaire according to claim 1; and
the computer program product or the computing device.
